(19) United States
(12) Patent Application Publication
(10) Pub. No.: US 2006/0094495 A1
(43) Pub. Date: May 4, 2006

(54) Wagering game with competitive multi-tier event

(76) Inventors: Philip Gelber, Glen Ellyn, IL (US); Benjamin T. Gomez, Chicago, IL (US); Lisa Helfer, Chicago, IL (US); James Motyl, Chicago, IL (US)

Correspondence Address: Daniel J. Burnham;JENKENS & GILCHRIST, A PROFESSIONAL CORPORATION, Ste. 2600, 225 W. Washington, Chicago, IL, 60606-3418, US

(21) Appl. No.: 11/260,823

(22) Filed: Oct. 27, 2005

Related U.S. Application Data
(60) Provisional application No. 60/623,623, filed on Oct. 29, 2004.

(51) Int. Cl. A63F 13/00

(52) U.S. Cl. 463/20

(57) ABSTRACT

A method and gaming system for playing a wagering game at a plurality of gaming terminals. The method includes conducting the wagering game at each of the plurality of gaming terminals. The plurality of gaming terminals are divided into a plurality of teams. A plurality of game elements are displayed and arranged into tiers. At least one turn-ending element is included. A first gaming terminal in a first team selects at least one of the plurality of game elements in each of the tiers until encountering the at least one turn-ending element or until one of the plurality of elements has been selected in each of the plurality of tiers. The selecting continues until a predetermined event occurs and a winning team is determined among the plurality of teams based upon the selecting.

### CROSS-REFERENCE TO RELATED APPLICATIONS

This application claims the benefit of priority of U.S. Provisional Patent Application No. 60/623,623, filed Oct. 29, 2004, which is hereby incorporated by reference in its entirety.

### FIELD OF THE INVENTION

The present invention relates generally to gaming terminals and, more particularly, to gaming terminals having a wagering game that includes at least two teams of players competing against each other.

### BACKGROUND OF THE INVENTION

Gaming machines, such as slot machines, video poker machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines.

Consequently, shrewd operators strive to employ the most entertaining and exciting machines available because such machines attract frequent play and, hence, increase profitability to the operator. In the competitive gaming machine industry, there is a continuing need for gaming machine manufacturers to produce new types of games, or enhancements to existing games, which will attract frequent play by enhancing the entertainment value and excitement associated with the game.

One concept that has been successfully employed to enhance the entertainment value of a game is that of a progressive jackpot. In the gaming industry, a “progressive” involves collecting coin-in data from participating gaming device(s) (e.g., slot machines), contributing a percentage of that coin-in data to a jackpot amount, and awarding that jackpot amount to a player upon the occurrence of a certain jackpot-won event. The percentage of the coin-in is determined prior to any result being achieved and is independent of any result. A jackpot-won event typically occurs when a “progressive winning position” is achieved at a participating gaming device. If the gaming device is a slot machine, a progressive winning position may, for example, correspond to alignment of progressive jackpot reel symbols along a certain payline. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate, which leads to further player excitement.

Another concept that has been employed is the use of a “secondary” or “bonus” game which may be played in conjunction with a “basic” game. The bonus game may comprise any type of game, either similar to or completely different from the basic game, and is entered upon the occurrence of a selected event or outcome of the basic game. Such a bonus game produces a significantly higher level of player excitement than the basic game because it provides a greater expectation of winning than the basic game.

In some current gaming terminals, the players play by themselves, and the gaming terminals are not linked to each other, which can keep award amounts low and also cause the player to feel isolated from other players around them. The individual players are not competing against other individual players. Also, nor are the individual players playing with any of the other individual players as a team to reach a common goal. The progressive games have tried to combat this by linking multiple gaming terminals together, where all the linked gaming terminals play for a common, large prize. However, the progressive games still do not connect the individuals playing at the various gaming terminals together in that the individuals are still not competing against each other or collaborating as if they are a part of a team.

Thus, there is a need for a wagering game that allows players at multiple different gaming terminals to be grouped into teams that compete against each other.

### SUMMARY OF THE INVENTION

The present invention solves the afore-mentioned problems by providing a method and system for playing a team competitive wagering game.

In one embodiment, the present invention provides a method of playing a wagering game at a plurality of gaming terminals, including conducting the wagering game at each of the gaming terminals, such that the gaming terminals divided into teams. Game elements are displayed and arranged into tiers. The game elements include at least one turn-ending element. A gaming terminal in a first team selects one of the game elements in each tier until either encountering a turn-ending element or until one game element has been selected in each of the tiers. The selecting continues until a predetermined event occurs and a winning team is determined. The winning team is awarded a wagering game payoff.

In another embodiment, the present invention involves a gaming system that includes a plurality of gaming terminals divided into teams. Each of the plurality of gaming terminals has a wagering game with a plurality of game elements arranged into tiers. The gaming elements each have associated indicia including at least one turn-ending indicia. Each of the gaming terminals displays the plurality of game elements and selects one of the plurality of gaming elements in each of the tiers until a turn-ending element is revealed or until a game element from each of the plurality of tiers has been selected.

In yet another embodiment, the present invention provides a gaming system including at least one display and a plurality of gaming terminals for playing a wagering game. The gaming system also includes a controller coupled to the gaming terminals and the display. The controller is operative to divide the plurality of gaming terminals into a plurality of teams and cause the display to display a plurality of game elements. The plurality of game elements are arranged in an array and cover a plurality of indicia. The plurality of indicia including at least one turn-ending element. For each of the plurality of gaming terminals, the controller is operative to reveal at least one of the plurality of indicia in each of the plurality of tiers until encountering the at least one turn-ending element or until one of the plurality of elements has been selected in each of the plurality of tiers. A winning team is determined based on the revealing.

Yet another embodiment of the present invention is a method of playing a wagering game at a plurality of gaming terminals. The method includes conducting the wagering game at each of the gaming terminals, such that the plurality of gaming terminals divided into a plurality of teams. A plurality of player-selectable elements are arranged in an array, and include at least one turn-ending element. Each gaming terminal in each of the teams receives player selections of the player-selectable elements until encountering the at least one turn-ending element. A value associated with the selections is determined for each of the player-selectable elements. A winning team is determined among the plurality of teams based upon the selections and a wagering game payoff is then awarded to the winning team having the highest value.

In yet another embodiment of the present invention, a method of playing a wagering game at a plurality of gaming terminals is provided. The method includes conducting the wagering game at each of the gaming terminals. The gaming terminals are divided into a first team and a second team. A plurality of game elements are arranged into an array and displayed on a display, the game elements including at least one turn-ending element. The method further includes selecting for a first gaming terminal in the first team at least one of the plurality of game elements until encountering the at least one turn-ending element or until an end location has been reached and then selecting for a first gaming terminal in the second team at least one of the plurality of game elements until encountering the at least one turn-ending element or until the end location has been reached. The selecting continues, alternating between a gaming terminal on the first team and a gaming terminal on the second team until one of the gaming terminals reaches the end location. A winning team is determined based upon the reaching of the end location and awarded a wagering game payoff.

### BRIEF DESCRIPTION OF THE DRAWINGS

The foregoing and other advantages of the invention will become apparent upon reading the following detailed description and upon reference to the drawings.

FIG. 1 is a perspective view of a video gaming terminal according to one embodiment of the present invention.

FIG. 2 is a block diagram of the gaming terminal of FIG. 1.

FIG. 3 is a gaming system of two sets of interconnected video gaming terminals and signage according to one embodiment of the present invention.

FIG. 4 illustrates a main display of the gaming terminal of FIG. 1.

FIG. 5 illustrates an initial bonus game screen of the gaming terminal of FIG. 1.

FIG. 6 illustrates another bonus game screen of the gaming terminal of FIG. 1.

FIG. 7 illustrates another bonus game screen of the gaming terminal of FIG. 1.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

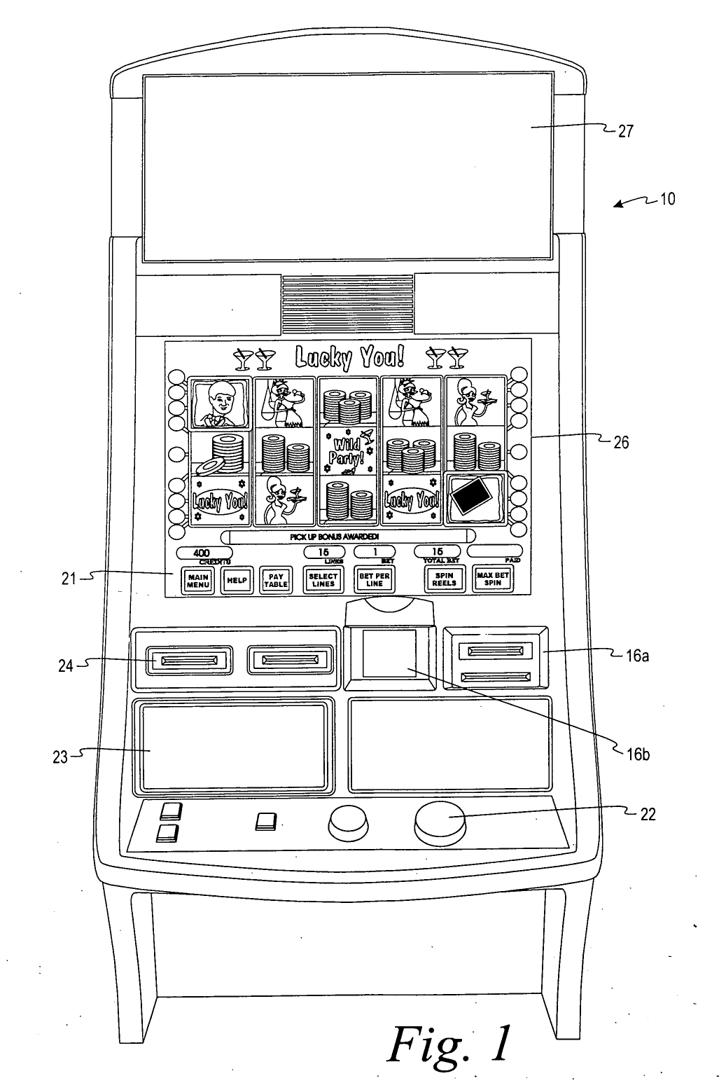

FIG. 1 shows a perspective view of a typical gaming terminal 10 used by gaming establishments, such as casinos. With regard to the present invention, the gaming terminal 10 may be any type of gaming terminal and may have varying structures and methods of operation. For example, the gaming terminal 10 may be a mechanical gaming terminal configured to play mechanical slots, or it may be an electromechanical or electrical gaming terminal configured to play video slots or a video casino game, such as blackjack, slots, keno, poker, etc.

As shown, the gaming terminal 10 includes input devices, such as a wager acceptor 16 (shown as a card wager acceptor 16a and a cash wager accepter 16b), a touch screen 21, a push-button panel 22, and a player-identification card reader 24. For outputs, the gaming terminal 10 includes a main display 26 for displaying information about the basic wagering game, and a secondary display 27 that may display an electronic version of a pay table, and/or also possibly game-related information or other entertainment features. While these typical components found in the gaming terminal 10 are described below, it should be understood that numerous other elements may exist and may be used in any number of combinations to create various forms of a gaming terminal.

The wager acceptor 16 may be provided in many forms, individually or in combination. The cash wager acceptor 16a may include a coin slot acceptor or a note acceptor to input value to the gaming terminal 10. The card wager acceptor 16b may include a card-reading device for reading a card that has a recorded monetary value with which it is associated. The card wager acceptor 16b may also receive a card that authorizes access to a central account, which can transfer money to the gaming terminal 10.

The push button panel 22 is typically offered, in addition to the touch screen 21, to provide players with an option on how to make their game selections. Alternatively, the push button panel 22 provides inputs for one aspect of operating the game, while the touch screen 21 allows for inputs needed for another aspect of operating the game.

The outcome of the basic wagering game is displayed to the player on the main display 26. The main display 26 may take the form of a cathode ray tube (CRT), a high resolution LCD, a plasma display, LED, or any other type of video display suitable for use in the gaming terminal 10. As shown, the main display 26 includes the touch screen 21 overlaying the entire monitor (or a portion thereof) to allow players to make game-related selections. Alternatively, the gaming terminal 10 may have a number of mechanical reels to display the game outcome, as long as it includes the secondary display 27 for displaying the bonus game feature described below.

The player-identification card reader 24 allows for the identification of a player by reading a card with information indicating his or her true identity. Currently, the identification is used by casinos for rewarding certain players with complimentary services or special offers. For example, a player may be enrolled in the gaming establishment's players' club and may be awarded certain complimentary services as that player collects points in his or her player-tracking account. The player inserts his or her card into the player-identification card reader 24, which allows the casino's computers to register that player's wagering at the gaming terminal 10. The gaming terminal 10 may use the secondary display 27 for providing the player with information about his or her account or other player-specific information.

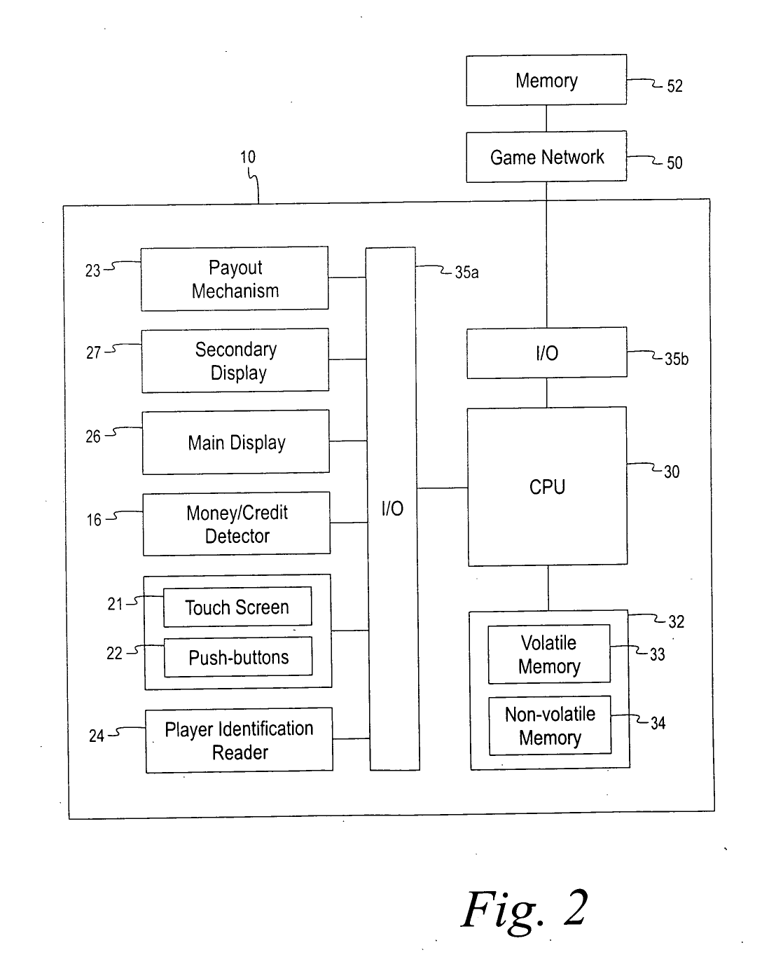

As shown in FIG. 2, the various components of the gaming terminal 10 are controlled by a central processing unit (CPU) 30 (such as a microprocessor or microcontroller). To provide the gaming functions, the CPU 30 executes a game program that allows for the randomly selected outcome. The CPU 30 is also coupled to or includes a local memory 32. The local memory 32 may comprise a volatile memory 33 (e.g., a random-access memory (RAM)) and a non-volatile memory 34 (e.g., an EEPROM). It should be appreciated that the CPU 30 may include one or more microprocessors. Similarly, the local memory 32 may include multiple RAM and multiple program memories.

Communications between the peripheral components of the gaming terminal 10 and the CPU 30 occur through input/output (I/O) circuits 35a. As such, the CPU 30 also controls and receives inputs from the peripheral components of the gaming terminal 10. Further, the CPU 30 communicates with external systems via the I/O circuits 35b. Although the I/O circuits 35 may be shown as a single block, it should be appreciated that the I/O circuits 35 may include a number of different types of I/O circuits.

The gaming terminal 10 is typically operated as part of a game control network 50 having control circuitry and memory devices. The game control network 50 may optionally include a system memory 52 for alternative storage of data. The game network 50 can include instructions for playing games, such as progressive jackpots that are contributed to by all or some of the gaming terminals 10 in the network 50. The gaming terminal 10 often has multiple serial ports, each port dedicated to providing data to a specific host computer system that performs a specific function (e.g., account system, player-tracking system, progressive game control system, etc. . . . ). To set up a typical serial communication hardware link to the host system, the typical RS-232 point-to-point communication protocol that is often present in the gaming terminal 10 is converted to an RS485 (or RS485-type) master-slave protocol so as to take advantage of some of the advantages of the RS485 capability (e.g., multi-drop capability that allows many gaming terminals 10 to communicate with the game control network 50). To perform this function, a custom interface board may be used by the gaming terminal 10 for each communication port in the gaming terminal 10. It should be noted that the gaming terminal 10 can initially be designed to be configured for a typical RS-485 protocol, instead of the typical RS-232 protocol. Further, the gaming terminal 10 may simply be designed for an Ethernet connection to the game control network 50.

In other embodiments, the information reader 24 may include a card reader, and the unique identifier provided at the gaming terminal 10 may be stored on a personal identification card, such as one described above. Or, the gaming terminal 10 includes a radio frequency identification device (RFID) transceiver or receiver so that an RFID transponder held by the player can be used to provide the unique identifier of the player at the gaming terminal 10 without the need to insert a card into the gaming terminal 10. RFID components can be those available from Pacific Northwest National Laboratory (under the United States Department of Energy) of Richland, Wash.

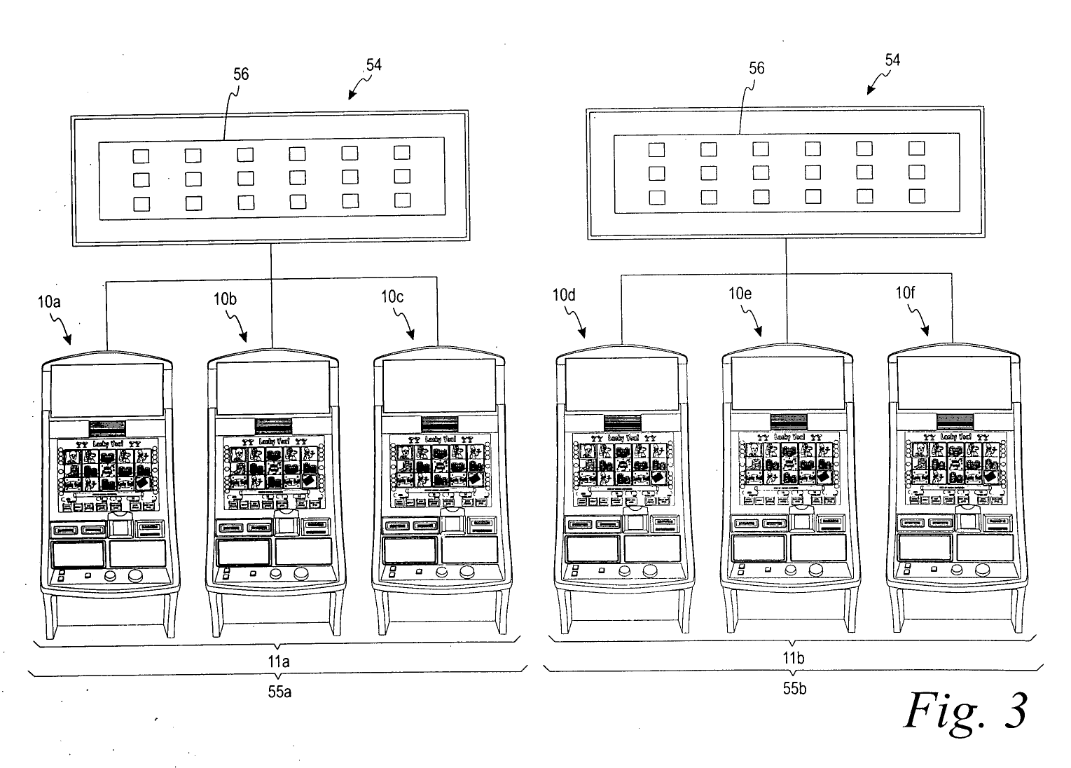

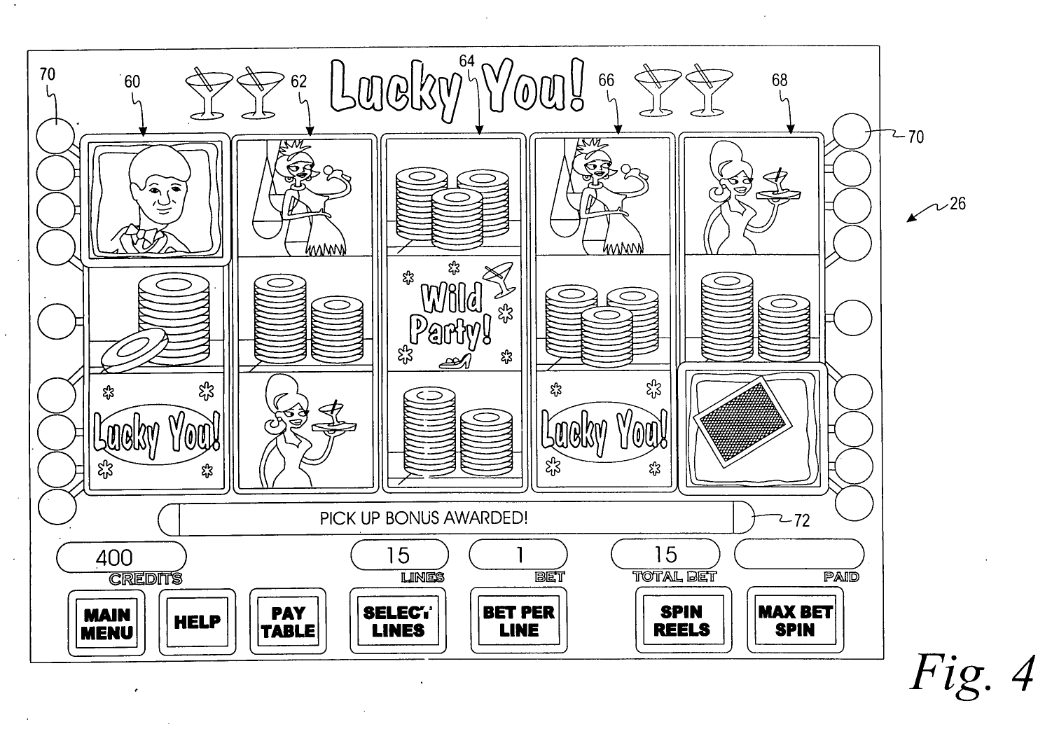

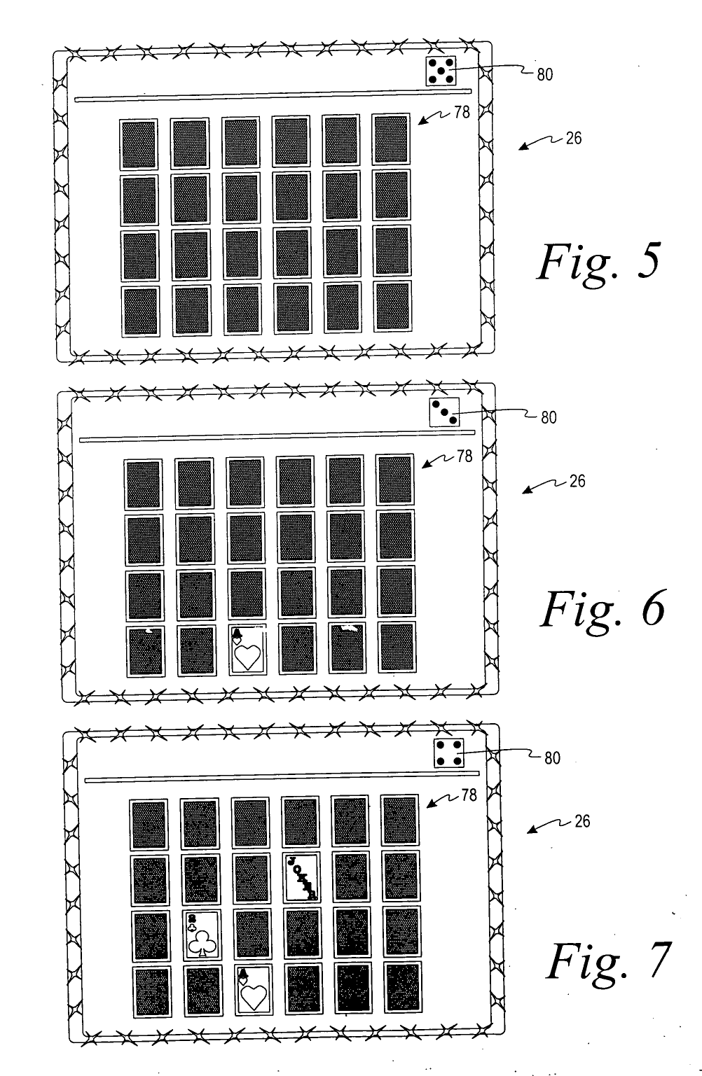

FIG. 3 shows two banks 11a, 11b of gaming terminals 10a-10c and 10d-10f. In this embodiment, the two banks 11a, 11b mare linked to each other via a wide-area network. The gaming terminals 10a-10c of the first bank 11a are interconnected. The first bank 11a of gaming terminals 10a-10c are all located under signage 54. The signage 54 includes a bonus game display 56, which will be described below in reference to FIGS. 5-7. In this embodiment, the first bank 11a of gaming terminals 10a-10c form a first team 55a during the wagering game. In other embodiments, the teams can be formed from multiple banks of gaming terminals, or gaming terminals that are not at the same bank, but that are in the same casino or even just playing the same game.

In this embodiment, the second bank 11b of gaming terminals 10d-10f are linked together as a second team 55b. The first team 55a and the second team 55b are competing against one another in the wagering game, as will be described below in reference to FIGS. 4-7.

One embodiment of the wagering game of the present invention will now be described in reference to FIGS. 4-7. As shown in FIG. 4, the wagering game begins with a basic game on the main display 26 of the gaming terminal 10. Each of the players on the two teams 55a, 55b plays the basic game as individuals. In this embodiment, the basic game is a slot machine game, with symbols on five different reels 60, 62, 64, 66, 68. The reels 60-68 may be either traditional mechanical reels or they may be computer-generated images of reels, with each reel composed of a plurality of symbols. The payline indicators 70 indicate a randomly selected outcome for each payline, which is the combination of symbols on the reels 60-68. Thereafter, an outcome indicator 72 indicates whether the outcome has resulted in a payout, a progressive jackpot, a bonus game, or whether it resulted in a non-winning outcome. While multiple paylines are shown, a gaming terminal 10 with a single payline will also work with the present invention.

In the present example, the wagering game follows the theme of a Las Vegas Party, where the symbols represent different things generally associated with Las Vegas (e.g., people, singers, waitresses, cards, chips, dice, drinks, etc. . . . ). Various combinations of the symbols can result in prizes, including monetary and non-monetary prizes. The non-monetary prizes include free spins, multipliers, entry into a bonus game, entry into a progressive game, etc.

In this particular embodiment, a particular combination of symbols generates entry into a relay race bonus game that has a predetermined award. The game enters the bonus stage when a particular symbol is present on a payline of the first reel 60 and a different symbol is present on a payline in the fifth reel 68. In this embodiment, the combination illustrated is a symbol of a person 74 in the first reel 60 along with a deck of cards symbol 76 in the fifth reel 68. In other embodiments, other symbol combinations (including symbols on other reels) may trigger the bonus game.

In some embodiments there may be minimum requirements for a player to enter the base game. These may include: the player placing a minimum wager; the player being registered on the network 50, the player playing all lines; etc. . . . . In some embodiments, the players on the teams may be randomly selected and in others the teams may be predetermined, for example, by prior registration or by gaming terminal.

Once one of the players on either of the teams 55a, 55b achieves the bonus game, all of the gaming terminals 10a-10f will automatically switch to the bonus game.

Turning now to FIG. 5, a display of the bonus game is shown that is triggered by the symbol combination in the basic game, as shown in FIG. 4. In this embodiment, the bonus game includes a number of cards 78 placed face down in an array on the main display 26. The bonus game may also be shown on the bonus game display 56 of the signage 54 above each of the banks 11a, 11b of gaming terminals. The cards 78 represent a multi-tiered bonus game. A die 80 is shown in the corner of the main display 26 and/or bonus display 56.

After the bonus game is entered, one of the players on the first team 55a (preferably the player that triggered the bonus, but the player may be chosen randomly by the network 50) attempts to move through the multiple tiers without hitting a turn-ending symbol, or a “pooper,” illustrated in this case as a “Joker.” The die will roll, and a side of the die will be randomly chosen by the network 50.

As shown in FIG. 6, the die is rolled and shows a “three.” The third card in the first tier of cards is now revealed. It reveals the ace of hearts. While the illustrated symbols correspond to card symbols, it is also possible that the symbols may be reel symbols or other types of indicia. Also, in some embodiments, the indicia may correspond to certain prizes, e.g., the ace of hearts may result in the player (or everyone on the player's team) being awarded five credits. The awards may be monetary (credits) or non-monetary (e.g., free spins, etc.) in nature. Also, in other embodiments, the cards, when turned over may simply reveal the prize won. In other embodiments, some of the cards may correspond to prizes, while others just allow the player to continue playing the bonus game.

In the illustrated embodiment, because the revealed card is not a turn-ending symbol, the player moves to the second tier, and the die is rolled again. The next die roll was a two (not shown), and the card revealed the two of clubs (FIG. 7). Play continues, on the third tier, and the die roll is a four, which reveals a joker. This player did not make it through all of tiers without hitting a turn-ending symbol. The play now turns to a player on the second team 55b who attempts to make it through all four tiers. The cards may be the same cards (e.g., the ace of hearts may be behind the third card of the first tier) or the cards may be different. After each player on both teams 55a, 55b either reveals a turn-ending symbol or makes it through all four tiers, the bonus game ends and the predetermined bonus award is distributed to the winning team.

The winning team may be determined by whichever team 55a, 55b has the greatest number of players make it through all four tiers without hitting a turn-ending symbol. In case of a tie, a tie-breaker such as whichever team earned the greatest number of free credits in the bonus game, may be instituted to determine the winner. In another embodiment, the tie-breaker may result in the continuing to play the bonus game until there is no longer a tie. In some embodiments, a tie may result in both teams 55a, 55b splitting the bonus award.

The winning team may also be decided by whichever team achieved the greatest number of free credits (or other award) during the bonus game, if the cards represent bonus awards such as free credits.

The predetermined bonus award may be added to by any awards the player achieved during the bonus game. In some embodiments, only the winning team may collect their additional awards, while in other embodiments, both teams are awarded the prizes won while traveling over the tiers.

In another embodiment of the bonus game, once a player on a team hits a turn-ending symbol, that symbol is replaced by a non-turn-ending symbol for the next player from the same team. For example, in the embodiment illustrated in FIG. 7, if the player from the first team 55a rolls a four and reveals a joker in the third tier, that joker will be removed and replace with another card, e.g., a three of spades when the next person from the first team 55a plays. This allows the players who land on the turn-ending symbols to have a positive impact on the game, despite their failure to make it past all four tiers.

In yet another embodiment, the multi-tiered event is a multi-tiered path. The first team to have a player reach the end of the path is the winning team. In this embodiment, each tier has at least one turn-ending symbol, and if a player lands on that turn-ending symbol, a player from the next team gets a turn. In this embodiment, once a player lands on a turn-ending symbol, that turn-ending symbol may or may not be deleted for future players on that team.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method of playing a wagering game at a plurality of gaming terminals, comprising:
conducting the wagering game at each of the plurality of gaming terminals, the plurality of gaming terminals divided into a plurality of teams;
displaying a plurality of game elements arranged into a plurality of tiers, the game elements including at least one turn-ending element;
selecting, for a first gaming terminal in a first team, at least one of the plurality of game elements in each of the plurality of tiers until encountering the at least one turn-ending element or until one of the plurality of elements has been selected in each of the plurality of tiers;
continuing the selecting until a predetermined event occurs;
determining a winning team among the plurality of teams based upon the selections; and
awarding a wagering game payoff to the winning team.

2. The method of claim 1, wherein the predetermined event is each of the plurality of gaming terminals completing the selecting step and determining the winning team step comprises determining which of the plurality of teams had a greater number of players move through each of the plurality of tiers without selecting a turn-ending element.

3. The method of claim 1, wherein each of the plurality of game elements hide a prize award, the prize award of a particular one of the plurality of game elements being revealed when the particular one of the plurality of game elements is selected.

4. The method of claim 3, wherein the determining step comprises determining which of the plurality of teams accumulated more prize awards.

5. The method of claim 3, further comprising awarding the revealed prize award to at least one of a player at the particular one of the plurality of gaming terminals that caused the prize award to be revealed, every player on the particular one of the plurality of teams that caused the prize award to be revealed, or to the winning team.

6. The method of claim 3, wherein the wagering game payoff is the sum of all the revealed prize awards.

7. The method of claim 1, wherein the predetermined event occurs when one of the plurality of gaming terminals has selected one of the plurality of elements in each of the plurality of tiers;

8. A computer readable storage medium encoded with instructions for directing a gaming device to perform the method of claim 1.

9. A gaming system comprising:
at least one display;
a plurality of gaming terminals for playing a wagering game; and
a controller coupled to the at least two gaming terminals and the at least one display, the controller operative to
(i) divide the plurality of gaming terminals into a plurality of teams,
(ii) cause the display to display a plurality of game elements, the plurality of game elements arranged in an array and covering a plurality of indicia, the plurality of indicia including at least one turn-ending element,
(iii) reveal, for each of the plurality of gaming terminals, at least one of the plurality of indicia in each of the plurality of tiers until encountering the at least one turn-ending element or until one of the plurality of elements has been selected in each of the plurality of tiers, and
(iv) determine a winning team based on the revealing.

10. The system of claim 9, wherein each of the plurality of indicia represent a prize award.

11. The system of claim 9, wherein the at least one display is included in signage above at least one of the plurality of gaming terminals.

12. The system of claim 9, wherein the at least one display includes a display on each of the plurality of gaming terminals.

13. The system of claim 9, wherein the controller is housed in one of the plurality of gaming terminals.

14. The system of claim 9, wherein the controller is housed outside of the plurality of gaming terminals.

15. The system of claim 9, further comprising a terminal controller in each of the plurality of gaming terminals, the terminal controller adapted to communicate with the controller.

16. The system of claim 9, wherein the wagering game includes a basic game and the plurality of game elements are displayed during the basic game.

17. The system of claim 9, wherein the wagering game includes a basic game and a bonus game, the basic game having a plurality of symbols that indicate a randomly selected outcome of the basic game, and the plurality of game elements are displayed on each of the plurality of gaming terminals in response to the randomly selected outcome at one of the plurality of gaming terminals being a start-bonus game outcome.

18. A method of playing a wagering game at a plurality of gaming terminals, comprising:
conducting the wagering game at each of the plurality of gaming terminals, the plurality of gaming terminals divided into a plurality of teams;
displaying a plurality of player-selectable elements arranged in an array, the player-selectable elements including at least one turn-ending element;
for each gaming terminal in each of the plurality of teams, receiving player selections of the plurality of player-selectable elements until encountering the at least one turn-ending element;
for each of the plurality of teams, determining a value associated with the selections;
determining a winning team among the plurality of teams based upon the selections; and
awarding a wagering game payoff to the winning team having the highest value.

19. The method of claim 18, further comprising each of the plurality of teams taking turns and displaying each turn.

20. The method of claim 18, wherein the same array of player-selectable elements is used for each of the plurality of gaming terminals.

21. The method of claim 20, further comprising pre-revealing the player-selectable elements in the array prior to each player selection.
